(19) United States
(12) Patent Application Publication
(10) Pub. No.: US 2018/0076483 A1
(43) Pub. Date: Mar. 15, 2018

(54) NON-AQUEOUS ELECTROLYTE OF LITHIUM-ION BATTERY AND LITHIUM-ION BATTERY

(71) Applicant: SHENZHEN CAPCHEM TECHNOLOGY CO., LTD, Shenzhen (CN)

(72) Inventors: Qiao SHI, Shenzhen (CN); Muchong LIN, Shenzhen (CN); Guchun CHEN, Shenzhen (CN); Shiguang HU, Shenzhen (CN)

(73) Assignee: SHENZHEN CAPCHEM TECHNOLOGY CO., LTD, Shenzhen (CN)

(21) Appl. No.: 15/557,780

(22) PCT Filed: Oct. 9, 2015
(86) PCT No.: PCT/CN2015/091506

§ 371 Date: Sep. 12, 2017

(30) Foreign Application Priority Data
Aug. 3, 2015 (CN) 201510481841.3

(51) Int. Cl. H01M 10/0567; H01M 10/0525; H01M 10/0568; H01M 10/0569; H01M 4/48; H01M 10/46

(52) U.S. Cl. CPC H01M 10/0567; H01M 10/0525; H01M 10/0568; H01M 2004/028; H01M 4/48; H01M 10/46; H01M 2300/0037; H01M 10/0569

(57) ABSTRACT

A non-aqueous electrolyte of a lithium-ion battery and a lithium-ion battery. The electrolyte comprises a non-aqueous organic solvent, a lithium salt and an additive. The additive comprises substances containing the following compounds (A) and (B): (A), where R₁, R₂, R₃ are independently selected from hydrocarbon groups having 1 to 4 carbon atoms respectively, and at least one of R₁, R₂, R₃ is an unsaturated hydrocarbon group containing a triple bond; (B) lithium bis(fluorosulfonyl)imide. The nonaqueous electrolyte of the lithium-ion battery enables the lithium-ion battery to have a lower impedance and better low-temperature and high-temperature performances.

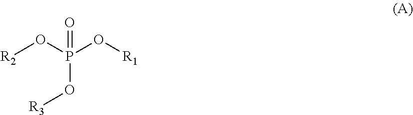

### TECHNICAL FIELD

The present invention relates to the technical field of lithium-ion battery electrolyte, particularly relates to a non-aqueous electrolyte for a lithium-ion battery, and a lithium-ion battery comprising the electrolyte.

### BACKGROUND OF THE INVENTION

Presently, lithium-ion batteries comprising non-aqueous electrolyte have more and more been used in the market of 3C consumer electronic products. And with the development of new energy vehicles, lithium-ion batteries comprising non-aqueous electrolyte have more and more been popularized as the motive power system of the vehicles. Although these batteries comprising non-aqueous electrolyte have been put into practical use, their durability is still unsatisfactory. In particular, their service life at a high temperature of 45° C. is relatively short. Moreover, motor vehicles and energy storage systems require that lithium-ion batteries comprising non-aqueous electrolyte be able to work normally in cold regions. Hence, both high-temperature and low-temperature performance should be taken into account.

In a lithium-ion battery comprising non-aqueous electrolyte, the non-aqueous electrolyte is the key factor affecting the high-temperature and low-temperature performance of the battery. In particular, the additive in the non-aqueous electrolyte is especially important for the achievement of the high-temperature and low-temperature performance of the battery. The non-aqueous electrolyte presently put into practical use employs a conventional film-forming additive such as vinylene carbonate (VC) to ensure excellent cycling performance of the battery. However, VC has a poor stability under high voltage, such that it is hard to satisfy the requirement of 45° C. cycling performance under high-voltage and high-temperature conditions.

Patent document U.S. Pat. No. 6,919,141B2 discloses a phosphate ester containing an unsaturated bond as a non-aqueous electrolyte additive. The additive can reduce the irreversible capacity of a lithium-ion battery and enhance the cycling performance of the lithium-ion battery. Similarly, patent document 201410534841.0 discloses a phosphate ester compound containing a triple bond as a novel film-forming additive. The additive can not only improve high-temperature cycling performance, but also markedly improve storage performance. However, scientific researchers in the art discovered in their research that the passivation film formed at an electrode interface by the phosphate ester additive containing a triple bond has a relatively poor electrical conductivity, which results in increased interface impedance and markedly deteriorated low-temperature performance. This limits the application of a non-aqueous lithium-ion battery in low temperature conditions.

### SUMMARY OF THE INVENTION

The present invention provides a non-aqueous electrolyte for a lithium-ion battery, the electrolyte having a good high-temperature performance and a low impedance. The present invention further provides a lithium-ion battery comprising the non-aqueous electrolyte for a lithium-ion battery.

According to a first aspect of the present invention, the present invention provides a non-aqueous electrolyte for a lithium-ion battery, comprising a non-aqueous organic solvent, a lithium salt and an additive, the additive including a substance containing compounds (A) and (B):

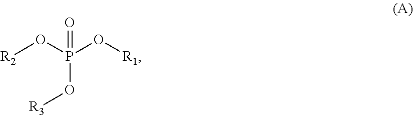

wherein R₁, R₂ and R₃ are respectively independently selected from a hydrocarbon group having a carbon atom number of 1-4, and at least one of R₁, R₂ and R₃ is an unsaturated hydrocarbon group containing a triple bond; and

(B) lithium bis(fluorosulfonyl)imide.

As a further improved solution of the present invention, compound (A) accounts for 0.1% to 2%, preferably 0.2% to 1% of the total weight of the electrolyte, and compound (B) accounts for 0.1% to 10%, preferably 0.3% to 5% of the total weight of the electrolyte.

As a further improved solution of the present invention, the ratio of the percentage of compound (B) with respect to the weight of the electrolyte to the percentage of compound (A) with respect to the weight of the electrolyte is equal to or higher than 0.2.

As a further improved solution of the present invention, compound (A) is selected from one or more of the following compounds 1 to 6:

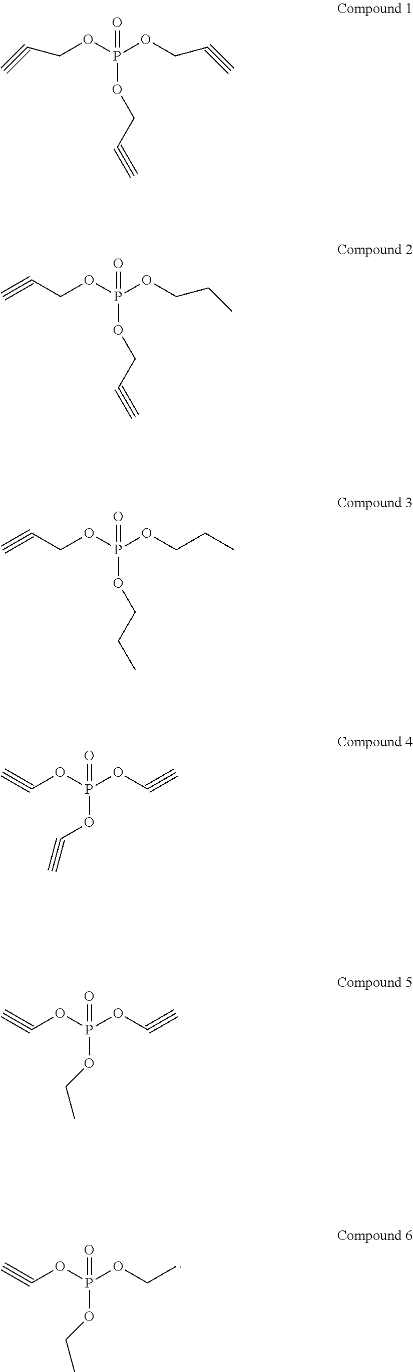

As a further improved solution of the present invention, the non-aqueous organic solvent is a mixture of a cyclic carbonate ester and a linear carbonate ester, the cyclic carbonate ester being selected from one or two or more of ethylene carbonate, propylene carbonate and butylene carbonate, and the linear carbonate ester being selected from one or two or more of dimethyl carbonate, diethyl carbonate, ethyl methyl carbonate and methyl propyl carbonate.

As a further improved solution of the present invention, the lithium salt is selected from one or two or more of LiPF₆, LiBF₄, LiSbF₆, LiAsF₆, LiN(SO₂CF₃)₂, LiN(SO₂C₂F₅)₂, LiC(SO₂CF₃)₃ and LiN(SO₂F)₂.

As a further improved solution of the present invention, the additive also includes one or two or more of vinylene carbonate, 1,3-propane sultone, fluorinated ethylene carbonate and vinyl ethylene carbonate.

According to a second aspect of the present invention, the present invention provides a lithium-ion battery, comprising a cathode, an anode and a separator membrane disposed between the cathode and the anode, and further comprising the non-aqueous electrolyte for a lithium-ion battery according to the first aspect of the present invention.

As a further improved solution of the present invention, the cathode is selected from one or two or more of LiCoO₂, LiNiO₂, LiMn₂O₄, LiCo_{1-y}M_{y}O₂, LiNi_{1-y}M_{y}O₂, LiMn_{2-y}M_{y}O₄ and LiNiₓCo_{y}Mn_{z}M_{1-x-y-z}O₂, wherein M is selected from one or two or more of Fe, Co, Ni, Mn, Mg, Cu, Zn, Al, Sn, B, Ga, Cr, Sr, V and Ti, and 0≦y≦1, 0≦x≦1, 0≦z≦1 and x+y+z≦1.

As a further improved solution of the present invention, the lithium-ion battery has a charging cut-off voltage of higher than or equal to 4.35 V.

The non-aqueous electrolyte for a lithium-ion battery according to the present invention comprises compound (A), which can form a film on the cathode and the anode, effectively protect the cathode and anode, enhance the high-temperature performance of the lithium-ion battery, especially high-temperature cycling performance; and further comprises lithium bis(fluorosulfonyl)imide, which mainly serves to decrease the impedance of the battery and increase the low-temperature performance of the battery. The non-aqueous electrolyte for a lithium-ion battery according to the present invention employs the combination of compound (A) and lithium bis(fluorosulfonyl)imide such that the lithium-ion battery achieves a lower impedance and a better low-temperature performance and high-temperature performance.

### DETAILED DESCRIPTION OF THE INVENTION

The present invention will be further described in detail with reference to embodiments and drawings.

An embodiment of the present invention provides a non-aqueous electrolyte for a lithium-ion battery, comprising a non-aqueous organic solvent, a lithium salt and an additive, the additive including a substance containing compounds (A) and (B):

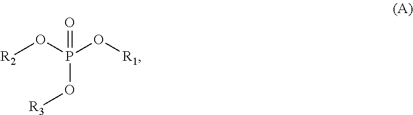

wherein R₁, R₂ and R₃ are respectively independently selected from a hydrocarbon group having a carbon atom number of 1-4, and at least one of R₁, R₂ and R₃ is an unsaturated hydrocarbon group containing a triple bond; and

(B) lithium bis(fluorosulfonyl)imide.

In a preferred embodiment of the present invention, compound (A) accounts for 0.1% to 2%, preferably 0.2% to 1% of the total weight of the electrolyte, and compound (B) accounts for 0.1% to 10%, preferably 0.3% to 5% of the total weight of the electrolyte.

By adding 0.1% to 2% of compound (A) in the above-said embodiment of the present invention, a film can be formed on the cathode and the anode, which can effectively protect the cathode and the anode and enhance the high-temperature performance of the lithium-ion battery, especially high-temperature cycling performance. When the content of compound (A) is lower than 0.1%, its film-forming effect on the cathode and the anode is poor, and the performance of the battery could not be duly improved; and when the content is higher than 2%, the film formed at the electrode interface is thick, which would severely increase the impedance of the battery and deteriorate the performance of the battery.

The lithium bis(fluorosulfonyl)imide (LIFSI) added in the above-said embodiment of the present invention mainly serves to decrease the impedance of the battery and increase the low-temperature performance of the battery. When the content of LIFSI is lower than 0.1%, the effect of decreasing the impedance is limited, and the low-temperature performance of the battery cannot be effectively enhanced; and when the content is higher than 10%, the high-temperature performance would be deteriorated.

In the above-said embodiment of the present invention, the combination of compound (A) and LIFSI allows the lithium-ion battery to have a lower impedance and a better low-temperature performance and high-temperature performance.

In a preferred embodiment of the present invention, the ratio of the percentage of compound (B) with respect to the weight of the electrolyte to the percentage of compound (A) with respect to the weight of the electrolyte is equal to or higher than 0.2. When the ratio is smaller than 0.2, the effect of decreasing the impedance is limited and the low-temperature performance of the battery cannot be effectively enhanced.

In a preferred embodiment of the present invention, compound (A) is selected from one or more of the following compounds 1 to 6:

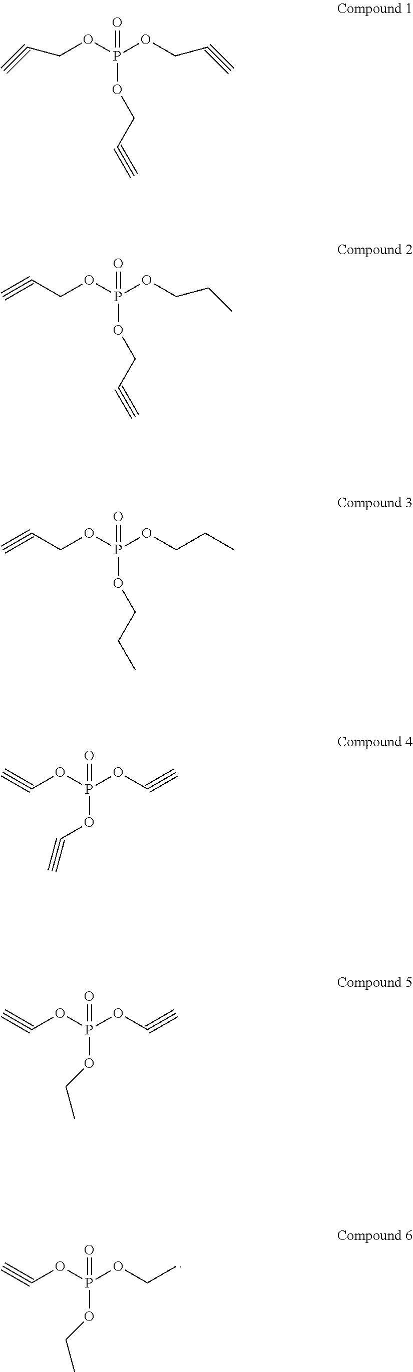

In a preferred embodiment of the present invention, the non-aqueous organic solvent is a mixture of a cyclic carbonate ester and a linear carbonate ester, the cyclic carbonate ester being selected from one or two or more of ethylene carbonate, propylene carbonate and butylene carbonate, and the linear carbonate ester being selected from one or two or more of dimethyl carbonate, diethyl carbonate, ethyl methyl carbonate and methyl propyl carbonate.

A mixed solution of the cyclic carbonate ester organic solvent having a high dielectric constant and the linear carbonate ester organic solvent having a low viscosity is used as the solvent for the lithium-ion battery electrolyte, such that the mixed solution of the organic solvents has a high ionic conductivity, a high dielectric constant and a low viscosity at the same time.

In a preferred embodiment of the present invention, the lithium salt is selected from one or two or more of LiPF₆, LiBF₄, LiSbF₆, LiAsF₆, LiN(SO₂CF₃)₂, LiN(SO₂C₂F₅)₂, LiC(SO₂CF₃)₃ and LiN(SO₂F)₂. Preferably, the lithium salt is a mixture of LiPF₆ or LiPF₆ with an alternative lithium salt.

In a preferred embodiment of the present invention, the additive also includes one or two or more of vinylene carbonate (VC), 1,3-propane sultone (1,3-PS), fluorinated ethylene carbonate (FEC) and vinyl ethylene carbonate (VEC).

The above-said film-forming additive can form a more stable SEI film on the surface of the graphite anode, thus markedly enhancing the cycling performance of the lithium-ion battery.

An embodiment of the present invention provides a lithium-ion battery, comprising a cathode, an anode and a separator membrane disposed between the cathode and the anode, and further comprising the non-aqueous electrolyte for a lithium-ion battery according to the first aspect.

In a preferred embodiment of the present invention, the cathode is selected from one or two or more of LiCoO₂, LiNiO₂, LiMn₂O₄, LiCo_{1-y}M_{y}O₂, LiNi_{1-y}M_{y}O₂, LiMn_{2-y}M_{y}O₄ and LiNiₓCo_{y}Mn_{z}M_{1-x-y-z}O₂, wherein M is selected from one or two or more of Fe, Co, Ni, Mn, Mg, Cu, Zn, Al, Sn, B, Ga, Cr, Sr, V and Ti, and 0≦y≦1, 0≦x≦1, 0≦z≦1 and x+y+z≦1.

In a preferred embodiment of the present invention, the lithium-ion battery has a charging cut-off voltage of higher than or equal to 4.35 V.

In an embodiment of the present invention, the cathode material is LiNi_{0.5}Co_{0.2}Mn_{0.3}O₂, the anode material is artificial graphite, and the charging cut-off voltage of the lithium-ion battery is equal to 4.35 V.

The present invention will be described in further detail by way of examples. It is to be appreciated that these examples are exemplary only and do not constitute a limitation to the scope of protection of the present invention.

### Example 1

1) Preparation of Electrolyte

Ethylene carbonate (EC), diethyl carbonate (DEC) and ethyl methyl carbonate (EMC) were mixed in a mass ratio of EC:DEC:EMC=1:1:1. Then, lithium hexafluorophosphate (LiPF₆) was added to a molar concentration of 1 mol/L. And then, the phosphate ester compound represented by compound 1 (the compound 1, compound 2 . . . recited in the particular examples refer to the compounds listed above having the corresponding numbering; the same applies in the following examples) was added in an amount of 0.5% based on the total mass of the electrolyte, and LIFSI was added in an amount of 0.5% based on the total mass of the electrolyte.

2) Preparation of a Cathode Plate

Lithium-nickel-cobalt-manganese oxide LiNi_{0.5}Co_{0.2}Mn_{0.3}O₂ as a cathode active material, Super-P as a conductive carbon black, and polyvinylidene fluoride (PVDF) as a binding agent were mixed in a mass ratio of 93:4:3 and then dispersed in N-methyl-2-pyrrolidone (NMP) to obtain a cathode slurry. The slurry was evenly coated onto both sides of an aluminum foil, and the coated aluminum foil was subjected to oven drying, calendering and vacuum drying. An aluminum outgoing line was welded with an ultrasonic welding machine to obtain the cathode plate, which had a thickness of between 120-150 μm.

3) Preparation of an Anode Plate

Artificial graphite as an anode active material, Super-P as a conductive carbon black, and styrene-butadiene rubber (SBR) and carboxymethylcellulose (CMC) as a binding agent were mixed in a mass ratio of 94:1:2.5:2.5 and then dispersed in deionized water to obtain an anode slurry. The slurry was coated onto both sides of a copper foil, and the coated copper foil was subjected to oven drying, calendering and vacuum drying. A nickel outgoing line was welded with an ultrasonic welding machine to obtain the anode plate, which had a thickness of between 120-150 μm.

4) Preparation of a Battery Cell

A microporous polyethylene membrane having a thickness of 20 μm was placed between the cathode plate and the anode plate as the separator membrane. The sandwich structure consisting of the cathode plate, the anode plate and the separator membrane was wound, and the wound article was flattened and placed into a square aluminum metal casing. Outgoing lines of the cathode and the anode were respectively welded to the corresponding positions on a cover plate, and the cover plate was welded together with the metal casing with a laser welding machine to obtain the battery cell to be injected with the electrolyte prepared.

5) Filling of the Battery Cell and Battery Formation

In a glove box with the dew point being controlled at below −40° C., the electrolyte prepared above was injected into the battery cell via a liquid injection hole in an amount of the electrolyte such that any interspace in the battery cell was filled. Then, battery formation was conducted in the following steps: performing constant-current charging for 3 min at 0.05 C, performing constant-current charging for 5 min at 0.2 C, performing constant-current charging for 25 min at 0.5 C, standing for 1 hour, shaping and sealing, then further performing constant-current charging at 0.2 C to 4.35V, standing for 24 hours at ambient temperature, then performing constant-current discharging at 0.2 C to 3.0 V.

6) Testing of High-Temperature Cycling Performance

The battery was placed in an oven at a constant temperature of 45° C. Constant-current charging was performed at 1C to 4.35 V, then constant-voltage charging was performed until the current dropped to 0.1C, and then constant-current discharging was performed at 1C to 3.0 V. 500 cycles was performed in this way. The discharge capacity at the 1^{st} cycle and the discharge capacity at the 500^{th} cycle were recorded, and the capacity retention rate for high-temperature cycling was calculated according to the following formula:

Capacity retention rate=discharge capacity at the 500^{th} cycle/discharge capacity at the 1^{st} cycle

7) Testing of High-Temperature Storage Performance

The battery having been subjected to battery formation was subjected to constant-current and constant-voltage charging at 1C to 4.35 V. The initial discharge capacity of the battery was measured. The battery was stored at 60° C. for 30 days, and then discharged at 1C to 3V. The retention capacity and the recovery capacity of the battery were measured, and the battery capacity retention rate and the battery capacity recovery rate were calculated according to the following formulas:

Battery capacity retention rate (%)=retention capacity/initial capacity×100%;

Battery capacity recovery rate (%)=recovery capacity/initial capacity×100%.

8) Testing of Low-Temperature Performance

At 25° C., the battery having been subjected to battery formation was subjected to constant-current and constant-voltage charging at 1C to 4.35 V, then subjected to constant-current discharging at 1C to 3.0 V, and the discharge capacity was recorded. Then, the battery was subjected to constant-current and constant-voltage charging at 1C to 4.35 V, stood in an environment of −20° C. for 12 hours, and subjected to constant-current discharging at 0.3C to 3.0 V, and the discharge capacity was recorded.

Low-temperature discharging efficiency value at −20° C.=discharge capacity at 0.3C (−20° C.)/discharge capacity at 1C (25° C.)×100%.

### Example 2

This example was the same as example 1 except that 0.5% of compound 1 was replaced by 0.5% of compound 2 in the preparation of the electrolyte. The data of high-temperature cycling performance, high-temperature storage performance and low-temperature performance obtained by testing are shown in Table 1.

### Example 3

This example was the same as example 1 except that 0.5% of compound 1 was replaced by 0.5% of compound 4 in the preparation of the electrolyte. The data of high-temperature cycling performance, high-temperature storage performance and low-temperature performance obtained by testing are shown in Table 1.

### Example 4

This example was the same as example 1 except that 0.5% of compound 1 was replaced by 0.5% of compound 5 in the preparation of the electrolyte. The data of high-temperature cycling performance, high-temperature storage performance and low-temperature performance obtained by testing are shown in Table 1.

### Comparative Example 1

This comparative example was the same as example 1 except that compound 1 was not added in the preparation of the electrolyte. The data of high-temperature cycling performance, high-temperature storage performance and low-temperature performance obtained by testing are shown in Table 1.

### Comparative Example 2

This comparative example was the same as example 1 except that compound 1 was not added and 0.5% of LIFSI was replaced by 5% of LIFSI in the preparation of the electrolyte. The data of high-temperature cycling performance, high-temperature storage performance and low-temperature performance obtained by testing are shown in Table 1.

### Comparative Example 3

This comparative example was the same as example 1 except that LIFSI was not added in the preparation of the electrolyte. The data of high-temperature cycling performance, high-temperature storage performance and low-temperature performance obtained by testing are shown in Table 1.

### Comparative Example 4

This comparative example was the same as example 1 except that LIFSI was not added and 0.5% of compound 1 was replaced by 1% of compound 1 in the preparation of the electrolyte. The data of high-temperature cycling performance, high-temperature storage performance and low-temperature performance obtained by testing are shown in Table 1.

TABLE 1

| | | | Capacity | | | |
|---|---|---|---|---|---|---|
| | | | retention | | | |
| | | | rate at the | 60° C. storage | | Discharing |
| | | | 500^{th} cycle | for 30 days | | efficiency |
| | | | for cycling | Capacity | Capacity | value at |
| | | Additive and amount | at 45° C. | retention | recovery | −20° C. |
| | Cathode material | thereof | at 1 C | rate | rate | at 0.3 C |
| Example 1 | LiNi_{0.5}Co_{0.2}Mn_{0.3}O₂ | Compound 1 (0.5%) + | 80.8% | 85.7% | 95.1% | 55.6% |
| | | LIFSI (0.5%) | | | | |
| Example 2 | LiNi_{0.5}Co_{0.2}Mn_{0.3}O₂ | Compound 2 (0.5%) + | 76.1% | 81.9% | 91.7% | 58.3% |
| | | LIFSI (0.5%) | | | | |
| Example 3 | LiNi_{0.5}Co_{0.2}Mn_{0.3}O₂ | Compound 4 (0.5%) + | 73.8% | 78.5% | 89.0% | 53.2% |
| | | LIFSI (0.5%) | | | | |
| Example 4 | LiNi_{0.5}Co_{0.2}Mn_{0.3}O₂ | Compound 5 (0.5%) + | 75.2% | 79.4% | 89.7% | 57.5% |
| | | LIFSI (0.5%) | | | | |
| Comp. | LiNi_{0.5}Co_{0.2}Mn_{0.3}O₂ | LIFSI (0.5%) | 43.8% | 62.7% | 71.5% | 59.8% |
| example 1 | | | | | | |
| Comp. | LiNi_{0.5}Co_{0.2}Mn_{0.3}O₂ | LIFSI (5%) | 35.8% | 43.2% | 49.4% | 63.7% |
| example 2 | | | | | | |
| Comp. | LiNi_{0.5}Co_{0.2}Mn_{0.3}O₂ | Compound 1 (0.5%) | 80.2% | 83.8% | 91.1% | 47.2% |
| example 3 | | | | | | |
| Comp. | LiNi_{0.5}Co_{0.2}Mn_{0.3}O₂ | Compound 1 (1%) | 82.2% | 85.7% | 91.6% | 45.2% |
| example 4 | | | | | | |

It can be seen from the data in Table 1 that in comparison to the electrolytes not added with compound 1, 2, 4 or 5, the electrolytes added with any of these compounds showed markedly enhanced high-temperature cycling performance and high-temperature storage performance, and in comparison to the electrolytes not added with LIFSI, the electrolytes added with the compound showed markedly enhanced low-temperature performance. The electrolytes added with both compound 1, 2, 4 or 5 and LIFSI showed excellent high-temperature cycling performance, high-temperature storage performance and low temperature performance.

### Example 5

This example was the same as example 1 except that 0.5% of LIFSI was replaced by 1.5% of LIFSI in the preparation of the electrolyte. The data of high-temperature cycling performance, high-temperature storage performance and low-temperature performance obtained by testing are shown in Table 2.

### Example 6

This example was the same as example 1 except that 0.5% of compound 1 was replaced by 1% of compound and 0.5% of LIFSI was replaced by 3% of LIFSI in the preparation of the electrolyte. The data of high-temperature cycling performance, high-temperature storage performance and low-temperature performance obtained by testing are shown in Table 2.

### Example 7

This example was the same as example 1 except that 0.5% of compound 1 was replaced by 2% of compound 1 and 0.5% of LIFSI was replaced by 5% of LIFSI in the preparation of the electrolyte. The data of high-temperature cycling performance, high-temperature storage performance and low-temperature performance obtained by testing are shown in Table 2.

TABLE 2

| | | | Capacity | | | |
|---|---|---|---|---|---|---|
| | | | retention | | | |
| | | | rate at the | 60° C. storage | | Discharing |
| | | | 500^{th} cycle | for 30 days | | efficiency |
| | | | for cycling | Capacity | Capacity | value at |
| | | Additive and amount | at 45° C. | retention | recovery | −20° C. |
| | Cathode material | thereof | at 1 C | rate | rate | at 0.3 C |
| Example 5 | LiNi_{0.5}Co_{0.2}Mn_{0.3}O₂ | Compound 1 (0.5%) + | 79.2% | 83.7% | 90.5% | 61.5% |
| | | LIFSI (1.5%) | | | | |
| Example 6 | LiNi_{0.5}Co_{0.2}Mn_{0.3}O₂ | Compound 1 (1%) + | 83.1% | 88.1% | 94.6% | 64.7% |
| | | LIFSI (3%) | | | | |
| Example 7 | LiNi_{0.5}Co_{0.2}Mn_{0.3}O₂ | Compound 1 (2%) + | 88.8% | 87.9% | 95.5% | 61.4% |
| | | LIFSI (5%) | | | | |
| Example 1 | LiNi_{0.5}Co_{0.2}Mn_{0.3}O₂ | Compound 1 (0.5%) + | 80.8% | 83.9% | 90.8% | 55.6% |
| | | LIFSI (0.5%) | | | | |

It can be seen from the data in Table 2 that when the amount of compound 1 was increased from 0.5% to 2%, the high-temperature performance and the high-temperature storage performance gradually increased; and when the amount of LIFSI was increased from 0.5% to 5%, the low-temperature performance showed a tendency to increase, and as the ratio of LIFSI to compound 1 increased, the low-temperature performance showed a tendency to increase.

### Example 8

This example was the same as example 1 except that 0.5% of LIFSI was replaced by 1.5% of LIFSI and 1% of vinylene carbonate (VC) was added in the preparation of the electrolyte. The data of high-temperature cycling performance, high-temperature storage performance and low-temperature performance obtained by testing are shown in Table 3.

### Example 9

This example was the same as example 1 except that 0.5% of LIFSI was replaced by 1.5% of LIFSI and 1% of fluorinated ethylene carbonate (FEC) was added in the preparation of the electrolyte. The data of high-temperature cycling performance, high-temperature storage performance and low-temperature performance obtained by testing are shown in Table 3.

### Example 10

This example was the same as example 1 except that 0.5% of LIFSI was replaced by 1.5% of LIFSI and 1% of vinyl ethylene carbonate (VEC) was added in the preparation of the electrolyte. The data of high-temperature cycling performance, high-temperature storage performance and low-temperature performance obtained by testing are shown in Table 3.

### Comparative Example 5

This comparative example was the same as example 1 except that 0.5% of compound 1 and 0.5% of LIFSI were replaced by 1% of vinylene carbonate (VC) in the preparation of the electrolyte. The data of high-temperature cycling performance, high-temperature storage performance and low-temperature performance obtained by testing are shown in Table 3.

### Comparative Example 6

This comparative example was the same as example 1 except that 0.5% of compound 1 and 0.5% of LIFSI were replaced by 1% of fluorinated ethylene carbonate (FEC) in the preparation of the electrolyte. The data of high-temperature cycling performance, high-temperature storage performance and low-temperature performance obtained by testing are shown in Table 3.

### Comparative Example 7

This comparative example was the same as example 1 except that 0.5% of compound 1 and 0.5% of LIFSI were replaced by 1% of vinyl ethylene carbonate (VEC) in the preparation of the electrolyte. The data of high-temperature cycling performance, high-temperature storage performance and low-temperature performance obtained by testing are shown in Table 3.

TABLE 3

| | | | Capacity | | | |
|---|---|---|---|---|---|---|
| | | | retention | | | |
| | | | rate at the | 60° C. storage | | Discharing |
| | | | 500^{th} cycle | for 30 days | | efficiency |
| | | | for cycling | Capacity | Capacity | value at |
| | | Additive and amount | at 45° C. | retention | recovery | −20° C. |
| | Cathode material | thereof | at 1 C | rate | rate | at 0.3 C |
| Example 8 | LiNi_{0.5}Co_{0.2}Mn_{0.3}O₂ | Compound 1 (0.5%) + | 84.2% | 86.5% | 94.0% | 53.1% |
| | | LIFSI (1.5%) + VC (1%) | | | | |
| Example 9 | LiNi_{0.5}Co_{0.2}Mn_{0.3}O₂ | Compound 1 (0.5%) + | 83.2% | 83.4% | 91.7% | 58.9% |
| | | LIFSI (1.5%) + FEC (1%) | | | | |
| Example 10 | LiNi_{0.5}Co_{0.2}Mn_{0.3}O₂ | Compound 1 (0.5%) + | 83.5% | 87.9% | 95.2% | 47.9% |
| | | LIFSI (1.5%) + VEC (1%) | | | | |
| Comp. | LiNi_{0.5}Co_{0.2}Mn_{0.3}O₂ | VC (1%) | 65.1% | 75.6% | 81.2% | 57.1% |
| example 5 | | | | | | |
| Comp. | LiNi_{0.5}Co_{0.2}Mn_{0.3}O₂ | FEC(1%) | 63.3% | 70.1% | 77.3% | 59.7% |
| example 6 | | | | | | |
| Comp. | LiNi_{0.5}Co_{0.2}Mn_{0.3}O₂ | VEC (1%) | 66.0% | 75.7% | 82.0% | 45.6% |
| example 7 | | | | | | |

It can be seen from the data in Table 3 that further addition of compound 1 on the basis of addition of VC, FEC or VEC markedly increased the high-temperature cycling performance and the high-temperature storage performance of the battery, and further addition of LIFSI improved the low-temperature performance of the battery.

### Example 11

This example was the same as example 1 except that the cathode material LiNi_{0.5}Co_{0.2}Mn_{0.3}O₂ was replaced by LiNi_{1/3}Co_{1/3}Mn_{1/3}O₂, and 1% of vinylene carbonate (VC) was additionally added in the preparation of the electrolyte. The data of high-temperature cycling performance, high-temperature storage performance and low-temperature performance obtained by testing are shown in Table 4.

### Example 12

This example was the same as example 1 except that the cathode material LiNi_{0.5}Co_{0.2}Mn_{0.3}O₂ was replaced by LiNi_{0.8}Co_{0.15}Al_{0.05}O₂, and 1% of vinylene carbonate (VC) was additionally added in the preparation of the electrolyte. The data of high-temperature cycling performance, high-temperature storage performance and low-temperature performance obtained by testing are shown in Table 4.

### Example 13

This example was the same as example 1 except that the cathode material LiNi_{0.5}Co_{0.2}Mn_{0.3}O₂ was replaced by LiCoO₂, and 1% of vinylene carbonate (VC) was additionally added in the preparation of the electrolyte. The data of high-temperature cycling performance, high-temperature storage performance and low-temperature performance obtained by testing are shown in Table 4.

### Example 14

This example was the same as example 1 except that the cathode material LiNi_{0.5}Co_{0.2}Mn_{0.3}O₂ was replaced by LiMn₂O₄, and 1% of vinylene carbonate (VC) was additionally added in the preparation of the electrolyte. The data of high-temperature cycling performance, high-temperature storage performance and low-temperature performance obtained by testing are shown in Table 4.

### Comparative Example 8

This comparative example was the same as example 1 except that the cathode material LiNi_{0.5}Co_{0.2}Mn_{0.3}O₂ was replaced by LiNi_{1/3}Co_{1/3}Mn_{1/3}O₂, and 0.5% of compound 1 and 0.5% of LIFSI were replaced by 1% of vinylene carbonate (VC) in the preparation of the electrolyte. The data of high-temperature cycling performance, high-temperature storage performance and low-temperature performance obtained by testing are shown in Table 4.

### Comparative Example 9

This comparative example was the same as example 1 except that the cathode material LiNi_{0.5}Co_{0.2}Mn_{0.3}O₂ was replaced by LiNi_{0.8}Co_{0.15}Al_{0.05}O₂, and 0.5% of compound 1 and 0.5% of LIFSI were replaced by 1% of vinylene carbonate (VC) in the preparation of the electrolyte. The data of high-temperature cycling performance, high-temperature storage performance and low-temperature performance obtained by testing are shown in Table 4.

### Comparative Example 10

This comparative example was the same as example 1 except that the cathode material LiNi_{0.5}Co_{0.2}Mn_{0.3}O₂ was replaced by LiCoO₂, and 0.5% of compound 1 and 0.5% of LIFSI were replaced by 1% of vinylene carbonate (VC) in the preparation of the electrolyte. The data of high-temperature cycling performance, high-temperature storage performance and low-temperature performance obtained by testing are shown in Table 4.

### Comparative Example 11

This comparative example was the same as example 1 except that the cathode material LiNi_{0.5}Co_{0.2}Mn_{0.3}O₂ was replaced by LiMn₂O₄, and 0.5% of compound 1 and 0.5% of LIFSI were replaced by 1% of vinylene carbonate (VC) in the preparation of the electrolyte. The data of high-temperature cycling performance, high-temperature storage performance and low-temperature performance obtained by testing are shown in Table 4.

TABLE 4

| | | | Capacity | | | |
|---|---|---|---|---|---|---|
| | | | retention | | | |
| | | | rate at the | 60° C. storage | | Discharing |
| | | | 500^{th} cycle | for 30 days | | efficiency |
| | | | for cycling | Capacity | Capacity | value at |
| | | Additive and amount | at 45° C. | retention | recovery | −20° C. |
| | Cathode material | thereof | at 1 C | rate | rate | at 0.3 C |
| Example 11 | LiNi_{1/3}Co_{1/3}Mn_{1/3}O₂ | Compound 1 (0.5%) + | 83.6% | 87.7% | 94.3% | 61.4% |
| | | LIFSI (0.5%) + VC (1%) | | | | |
| Example 12 | LiNi_{0.8}Co_{0.15}Al_{0.05}O₂ | Compound 1 (0.5%) + | 75.4% | 79.5% | 86.7% | 62.7% |
| | | LIFSI (0.5%) + VC (1%) | | | | |
| Example 13 | LiCoO₂ | Compound 1 (0.5%) + | 79.5% | 84.8% | 91.4% | 62.8% |
| | | LIFSI (0.5%) + VC (1%) | | | | |
| Example 14 | LiMn₂O₄ | Compound 1 (0.5%) + | 74.4% | 77.8% | 84.6% | 59.7% |
| | | LIFSI (0.5%) + VC (1%) | | | | |
| Comp. | LiNi_{1/3}Co_{1/3}Mn_{1/3}O₂ | VC (1%) | 67.2% | 76.4% | 82.6% | 55.8% |
| example 8 | | | | | | |
| Comp. | LiNi_{0.8}Co_{0.15}Al_{0.05}O₂ | VC (1%) | 60.0% | 68.5% | 73.3% | 54.2% |
| example 9 | | | | | | |
| Comp. | LiCoO₂ | VC (1%) | 64.3% | 79.0% | 83.7% | 59.2% |
| example 10 | | | | | | |
| Comp. | LiMn₂O₄ | VC (1%) | 58.9% | 67.6% | 71.8% | 54.6% |
| example 11 | | | | | | |

It can be seen from the data in Table 4 that in the lithium-ion batteries using LiNi_{1/3}Co_{1/3}Mn_{1/3}O₂, LiNi_{0.8}Co_{0.15}Al_{0.05}O₂, LiCoO₂ or LiMn₂O₄ as the cathode material, the addition of compound 1 can improve the high-temperature cycling performance and high-temperature storage performance of the batteries, and addition of LIFSI can enhance the low-temperature performance of the batteries.

In summary of the above, addition of lithium bis(fluorosulfonyl)imide in the non-aqueous electrolyte for a lithium-ion battery according to the present invention allows the lithium-ion battery to achieve a lower impedance and a better low-temperature performance and high-temperature performance.

The above disclosures are intended to provide further detailed illustrations of the present invention by reference to particular embodiments and are not to be construed as limiting the practical implementation of the present invention to these illustrations. A number of simple deductions or substitutions can be made by a person of ordinary skill in the art to which the present invention pertains without departing from the concept of the present invention, and are deemed to be within the scope of protection of the present invention.

What is claimed is:

1. A non-aqueous electrolyte for a lithium-ion battery, comprising a non-aqueous organic solvent, a lithium salt and an additive, the additive including a substance containing compounds (A) and (B): 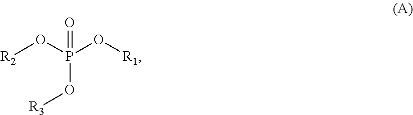
wherein R₁, R₂ and R₃ are respectively independently selected from a hydrocarbon group having a carbon atom number of 1-4, and at least one of R₁, R₂ and R₃ is an unsaturated hydrocarbon group containing a triple bond; and
(B) lithium bis(fluorosulfonyl)imide.

2. The non-aqueous electrolyte for a lithium-ion battery according to claim 1, wherein said compound (A) accounts for 0.1% to 2%, preferably 0.2% to 1% of the total weight of the electrolyte, and said compound (B) accounts for 0.1% to 10%, preferably 0.3% to 5% of the total weight of the electrolyte.

3. The non-aqueous electrolyte for a lithium-ion battery according to claim 1, wherein the ratio of the percentage of said compound (B) with respect to the weight of the electrolyte to the percentage of said compound (A) with respect to the weight of the electrolyte is equal to or higher than 0.2.

4. The non-aqueous electrolyte for a lithium-ion battery according to claim 1, wherein said compound (A) is selected from one or more of the following compounds 1 to 6:

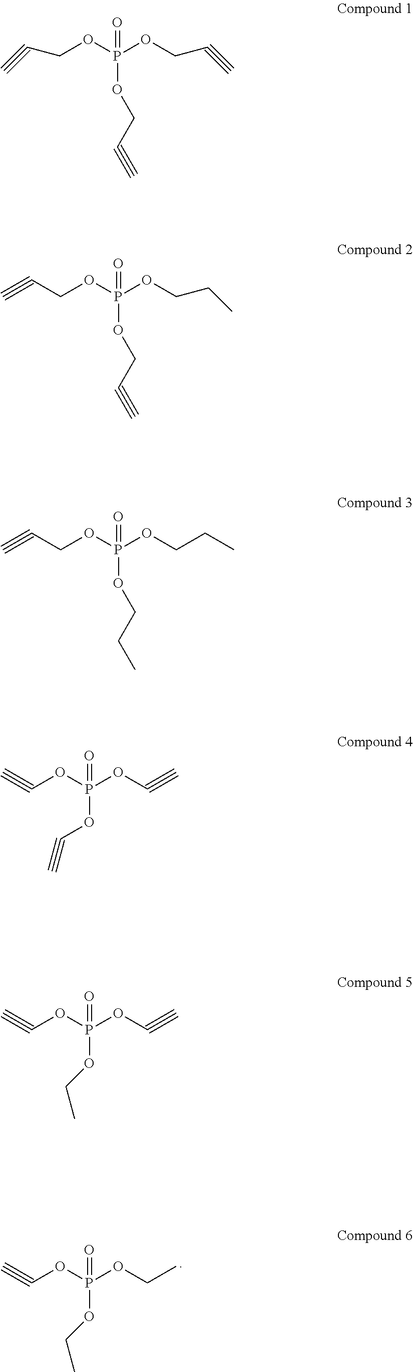

5. The non-aqueous electrolyte for a lithium-ion battery according to claim 1, wherein the non-aqueous organic solvent is a mixture of a cyclic carbonate ester and a linear carbonate ester, the cyclic carbonate ester being selected from one or two or more of ethylene carbonate, propylene carbonate and butylene carbonate, and the linear carbonate ester being selected from one or two or more of dimethyl carbonate, diethyl carbonate, ethyl methyl carbonate and methyl propyl carbonate.

6. The non-aqueous electrolyte for a lithium-ion battery according to claim 1, wherein the lithium salt is selected from one or two or more of LiPF₆, LiBF₄, LiSbF₆, LiAsF₆, LiN(SO₂CF₃)₂, LiN(SO₂C₂F₅)₂, LiC(SO₂CF₃)₃ and LiN(SO₂F)₂.

7. The non-aqueous electrolyte for a lithium-ion battery according to claim 1, wherein the additive also includes one or two or more of vinylene carbonate, 1,3-propane sultone, fluorinated ethylene carbonate and vinyl ethylene carbonate.

8. A lithium-ion battery, comprising a cathode, an anode and a separator membrane disposed between the cathode and the anode, wherein the lithium-ion battery further comprises the non-aqueous electrolyte for a lithium-ion battery according to claim 1.

9. The lithium-ion battery according to claim 8, wherein the cathode is selected from one or two or more of LiCoO₂, LiNiO₂, LiMn₂O₄, LiCo_{1-y}M_{y}O₂, LiNi_{1-y}M_{y}O₂, LiMn_{2-y}M_{y}O₄ and LiNiₓCo_{y}Mn_{z}M_{1-x-y-z}O₂, wherein M is selected from one or two or more of Fe, Co, Ni, Mn, Mg, Cu, Zn, Al, Sn, B, Ga, Cr, Sr, V and Ti, and 0≦y≦1, 0≦x≦1, 0≦z≦1 and x+y+z≦1.

10. The lithium-ion battery according to claim 8, wherein the lithium-ion battery has a charging cut-off voltage of higher than or equal to 4.35 V.

11. The lithium-ion battery according to claim 9, wherein the lithium-ion battery has a charging cut-off voltage of higher than or equal to 4.35 V.
